(19) United States
(12) Patent Application Publication
(10) Pub. No.: US 2010/0276509 A1
(43) Pub. Date: Nov. 4, 2010

(54) Drinking straw with filter member

(76) Inventor: James R. Mauro, Greer, SC (US)

Correspondence Address: J. BENNETT MULLINAX, LLC, P. O. BOX 26029, GREENVILLE, SC, 29616-1029, US

(21) Appl. No.: 12/387,289

(22) Filed: Apr. 30, 2009

(51) Int. Cl. A47G 21/18; B67D 5/58

(52) U.S. Cl. 239/33; 222/189.1

(57) ABSTRACT

A drinking straw that has a filter member is provided. In one embodiment, an outer wall extends in a longitudinal direction and has an outer surface that is curved. A central axis is located at the radial center of the outer wall and extends in the longitudinal direction. The outer wall has a first end and an oppositely disposed second end in the longitudinal direction. The first and second ends are open to allow the flow of fluid longitudinally through the outer wall. A filter member is present and at least partially defines a channel. The central axis may extend through the channel.

### FIELD OF THE INVENTION

The present invention relates generally to drinking straws for use in drinking liquids that contain seeds, tea leaves, or other non-liquid objects. More particularly, the present application involves a drinking straw that includes a filter member that functions to filter unwanted objects from the liquid to prevent same from being consumed by the user and that is arranged to minimize pressure drop during use.

### BACKGROUND

Drinking straws are known for use in the consumption of water and various beverages. Although capable of drawing desired liquid into the mouth of the user, other objects present in the liquid may be undesirably drawn into the mouth of the user when drinking. For example, citrus seeds or tea leaves present in the water or beverage may be drawn into the mouth of the user during use of the drinking straw and cause coughing or other discomfort. Further, the user is forced to either swallow the object or remove the object from his or her mouth which may cause embarrassment.

Filtered drinking devices are known for use in removing undesirable elements from contaminated liquids. For example, one such device features a chemical filter through which the liquid is transferred. The chemical filter functions to remove contaminants in the liquid such as particulate matter, undesirable odors and tastes, and harmful microorganisms. The filter can be made of activated carbon granules through which the liquid flows when the user applies suction to the straw. Although capable of filtering a liquid, such filtering devices induce a large pressure drop thus causing the user to apply significant force to draw in a lesser amount of the liquid than if the filter were not present. Further, filters of this type act to change the odor and taste of the liquid which is the entire reason why certain objects such as tea leaves and citrus particles are present in the liquid.

The inclusion of a filter into a drinking straw is thus problematic in that its presence causes a pressure drop which hampers the performance of the drinking straw. The use of walls within a drinking straw has been proposed in order to prevent larger sized particulate matter from being drawn through the straw and into the mouth of the user. The incorporation of walls into the structure of the drinking straw does not function to modify the resulting taste or odor of the water or beverage. Such walls have a rectangular cross-sectional shape and are located at the axial center of the drinking straw at one end of the straw. Alternatively, the wall could extend through the entire longitudinal length of the straw. Extension of the wall along the entire longitudinal length of the drinking straw, as opposed to just one end, may increase the chance of stopping particulate matter as it may become lodged at some point along the length of the wall even if it is initially capable of being drawn through and end of the straw.

Although capable of preventing certain sized particulates from being drawn through the drinking straw, such walls cause a significant pressure drop thus reducing the performance of the straw. In this regard, the rectangular cross-sectional shape of the wall causes a linear edge to be present that induces a turbulent flow that creates a pressure drop in the fluid. Further, the location of the wall at the axial center of the straw causes a significant pressure drop to be realized as fluid drawn through the straw encounters less resistance at the axial center than along the edges. As such, there remains room for variation and improvement in the art.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended Figs. in which:

FIG. 1 is cross-sectional side view of a drinking straw disposed within a glass of liquid to be consumed in accordance with one exemplary embodiment.

FIG. 2 is a perspective view of the drinking straw of FIG. 1.

FIG. 2A is a top view of the drinking straw of FIG. 1.

FIG. 3 is a perspective view of a drinking straw with a filter member located at one end in accordance with another exemplary embodiment.

FIG. 4 is a perspective view of a drinking straw with a filter member located at opposite ends and not located in the middle in accordance with another exemplary embodiment.

FIG. 5 is a perspective view of a drinking straw in accordance with another exemplary embodiment.

FIG. 5A is a top view of the drinking straw of FIG. 5.

FIG. 6 is a perspective view of a drinking straw with a filter member that has a different cross-sectional shape and has an open interior middle section in accordance with another exemplary embodiment.

FIG. 7 is a perspective view of a drinking straw in accordance with another exemplary embodiment.

FIG. 7A is top view of the drinking straw of FIG. 7.

FIG. 8 is a perspective view of a drinking straw in accordance with another exemplary embodiment.

FIG. 8A is a top view of the drinking straw of FIG. 8.

FIG. 9 is a perspective view of a drinking straw in accordance with another exemplary embodiment.

FIG. 9A is a top view of the drinking straw of FIG. 9.

FIGS. 10-23 are each top views and are each alternative exemplary embodiments of a drinking straw.

FIG. 24 is a perspective view of a drinking straw with an outer wall flexible section and a filter member flexible section in accordance with another embodiment.

Repeat use of reference characters in the present specification and drawings is intended to represent the same or analogous features or elements of the invention.

### DETAILED DESCRIPTION OF REPRESENTATIVE EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to 7 also includes a limit of up to 5, up to 3, and up to 4.5.

The present invention provides for a drinking straw 10 that has a filter member 30 that is configured to prevent unwanted objects 60, such as citrus seeds and tea leaves, from being drawn into the mouth of a user when drinking a fluid 28 such as a beverage or water. The drinking straw 10 is arranged so that it has a pair of open ends 24 and 26 through which fluid 28 is transported. The filter member 30 is located within an outer wall 14 and may be located along the entire longitudinal length of the drinking straw 10 or may be located only at the first end 24 and/or the second end 26. A channel 32 may be defined through which the fluid 28 may flow and may be positioned such that a central axis 12 of the drinking straw 10 extends through the channel 32. Additionally or alternatively, the channel 32 may be arranged so that it does not have a linear portion. In this regard, the entire cross-sectional shape of the channel 32 can be curved.

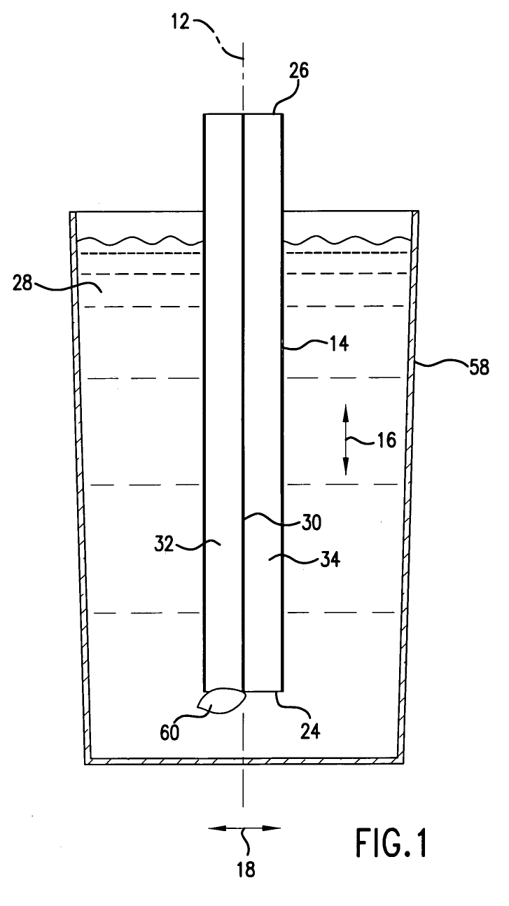

FIG. 1 illustrates a drinking straw 10 in accordance with one exemplary embodiment in which the straw 10 is disposed within a fluid 28 that is being consumed and is held by a glass 58. The fluid 28 may be water or a beverage and may contain objects 60 that are not intended for consumption. Application of suction at the second end 26 of the drinking straw 10 will act to draw fluid 28 and objects 60 through the first end 24 of the drinking straw 10. The object 60 may be smaller than the outer wall 14 of the drinking straw 10 and could potentially be drawn into the mouth of the user. A filter member 30 is located within the drinking straw 10 and is surrounded by the outer wall 14. The filter member 30 thus functions to block portions of the open first end 24 so that the object 60 cannot be transferred through the first end 24 and into the mouth of the user.

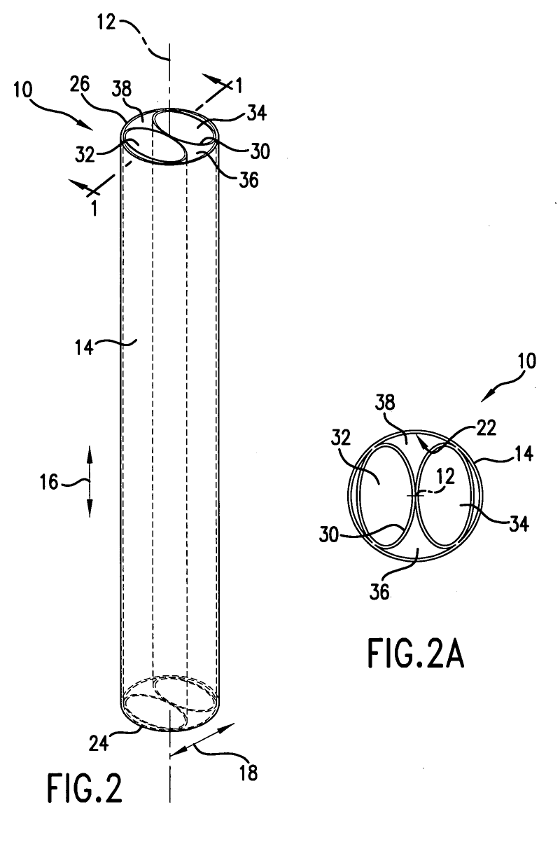

The drinking straw 10 of FIG. 1 is further illustrated in FIGS. 2 and 2A. The filter member 32 defines a pair of oval shaped channels 32 and 34. The filter member 32 extends the entire length of the drinking straw 10 from the first end 24 to the second end 26 in the longitudinal direction 16. The channels 32 and 34 are positioned so that the central axis 12 does not extend through either the first channel 32 or the second channel 34. The filter member 30 is contiguous with an inner surface 22 of the outer wall 14 and can be affixed thereon through adhesion, sonic welding, a frictional engagement, or may be integrally formed therewith. The material making up the filter member 30 can be the same material as that making up the outer wall 14 or may be a different material. In accordance with certain exemplary embodiments, the filter member 30 and the outer wall 14 are both made of plastic. The outer wall 14 may have an outer surface 20 that is curved. In this regard, the outer surface 20 may have a completely curved cross-sectional shape along its entire longitudinal length. However, it is to be understood that other exemplary embodiments are possible in which the outer surface 20 does not have a curved cross-sectional shape along its entire longitudinal length or does not have a curved cross-sectional shape at any point along its longitudinal length.

The cross-sectional shapes of the portions of the filter member 30 forming the channels 32 and 34 do not have linear portions. As such, the channels 32 and 34 do not have linear outer edges but instead have outer edges that are all curved. The outer edges of the channels 32 and 34 may have different radiuses of curvature but do not have linear portions. The absence of a linear portion in the cross-section of the channels 32 and 34 may function to reduce turbulence of fluid 28 flowing through the channels 32 and 34 during use of the drinking straw 10. Reduction of turbulence may cause the fluid 28 to be more easily drawn through the drinking straw 10 such that the user will be need to use less force to draw fluid 28 therethrough. Also, the reduction of turbulence within the channels 32 and 34 may allow a greater volume of fluid 28 to be drawn through the drinking straw 10 which will also reduce the effort exerted by the user of the drinking straw 10. The cross-sectional shape of the channels 32 and 34 may be the same throughout the entire longitudinal lengths of the channels 32 and 34 so that a discontinuity is not present to cause turbulence of fluid 28 flowing through the channels 32 and 34.

The filter member 30 in combination with the inner surface 22 of the outer wall 14 define a third channel 36 and a fourth channel 38. The third and fourth channels 36 and 38 likewise do not have a cross-sectional shape that has a linear portion so that turbulence in fluid 28 flowing through the channels 36 and 38 is reduced. Fluid 28 can be drawn through channels 36 and 38 to increase the volumetric flow capacity of the drinking straw 10. As illustrated, the channels 36 and 38 are positioned so that the central axis 12 does not extend through either one of the channels 36 and 38. As such, all of the channels present in the drinking straw 10 may have cross-sectional shapes that have some element of curvature imparted thereto. The filter member 30 thus restricts the cross-sectional size of the opening of the first end 24 and includes design elements to minimize pressure drop associated with the presence of the filter member 30 within the outer wall 14 so that the benefit of filtering objects 60 is realized with minimal increase in the amount of effort need to be exerted by the user to draw fluids 28 from the glass 58.

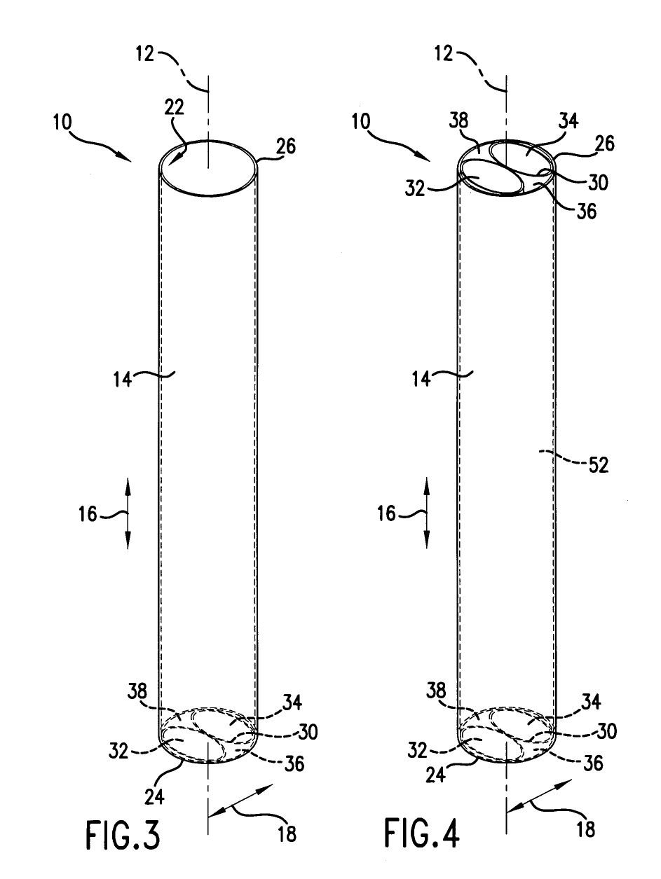

FIG. 3 shows an alternative exemplary embodiment of the drinking straw 10 in which the filter member 30 has the same cross-sectional shape as the filter member 30 of FIGS. 1 and 2. However, in this embodiment the filter member 30 does not extend along the entire longitudinal length of the outer wall 14 but instead is located only at the first end 24. The filter member 30 will necessarily have some thickness and thus have some extension in the longitudinal direction. The filter member 30 may extend up to 5%, up to 10%, up to 15% or up to 25% of the length of the outer wall 14 in the longitudinal direction 16. Further, when described as being located at the first end 24, the filter member 30 may be located at the immediate end of the outer wall 14 or may be located some distance from the end of the outer wall 14 such that the filter member 30 is inserted some distance within the outer wall 14 in the longitudinal direction 16. The second end 26 of the drinking straw 10 and the portions of the drinking straw 10 between the second end 26 and the first end 24 need not include the filter member 30. In this embodiment, the open portions within the outer wall 14 from the first end 24 will not impede the flow of fluid 28 therethrough thus increasing the efficiency of the drinking straw 10. The first end 24 may be inserted into the fluid 28 and the user may place the second end 26 into his or her mouth. Alternatively, the user may place the first end 24 into his or her mouth and insert the second end 26 into the fluid 28. In such an arrangement, the filter member 30 will still function to prevent unwanted objects 60 from being drawn into the mouth of the user.

The drinking straw 10 may be designed so that the filter member 30 is present at both the first end 24 and the second end 26 but not at the middle of the outer wall 14 in the longitudinal direction 16. FIG. 4 shows an exemplary embodiment in which the filter member 30 is discontinuous in the longitudinal direction 16. The cross-sectional shape of the filter member 30 is the same as the filter member 30 of FIGS. 1 and 2. The cross-sectional shape of the filter member 30 is consistent throughout its entire longitudinal length so that the shape of the channels 32, 34, 36, and 38 at the first end 24 and the second end 26 are the same. The filter member 30 can extend the same distance from the first end 24 and the second end 26 or its distance may be varied between the first and second ends. For example, the filter member 30 may extend along 10% of the longitudinal length of the outer wall 14 from the first end 24, but may extend only along 5% of the longitudinal length of the outer wall 14 from the second end 26. The filter member 30 is thus discontinuous in the longitudinal direction 16 so that an open middle portion 52 is defined in the interior of the outer wall 14. The open middle portion 52 may extend in the longitudinal direction 16 from 20%-50%, from 30%-60%, from 40%-80%, from 50%-90%, or from 90%-99% of the length of the outer wall 14 in the longitudinal direction 16. Placement of the filter member 30 at both ends 24 and 26 may function to prevent objects 60 from entering the interior of the outer wall 14 regardless of which end of the drinking straw 10 is placed into the fluid 28. Further, the presence of the filter member 30 at both ends 24 and 26 may serve as a back up should an object 60 pass through the filter member 30 at one of the ends 24 and 26. Provision of the open middle portion 52 may function to increase the volumetric flow rate of the drinking straw 10 so that less resistance is encountered by the user when using the drinking straw 10.

FIGS. 5 and 5A illustrate another exemplary embodiment of the drinking straw 10. The filter member 30 extends along the entire longitudinal length of the outer wall 14. The filter member 30 completely defines three channels 32, 34, and 36 that have completely round cross-sectional shapes. The channels 32, 34, and 36 are offset from the central axis 12 in the radial direction 18. The filter member 30 in combination with the inner surface 22 define additional channels 38, 40, and 42 that also do not have a cross-sectional shape with a linear portion. The additional channels 38, 40, and 42 each have two sides that have the same radius of curvature and a third side with a radius of curvature different from the first two sides. The sides of the additional channels 38, 40, and 42 that each have the different radius of curvature are defined by the inner surface 22. The filter member 30 defines a seventh channel 44 through which the central axis 12 extends. The seventh channel 44 likewise does not have a linear cross-sectional portion.

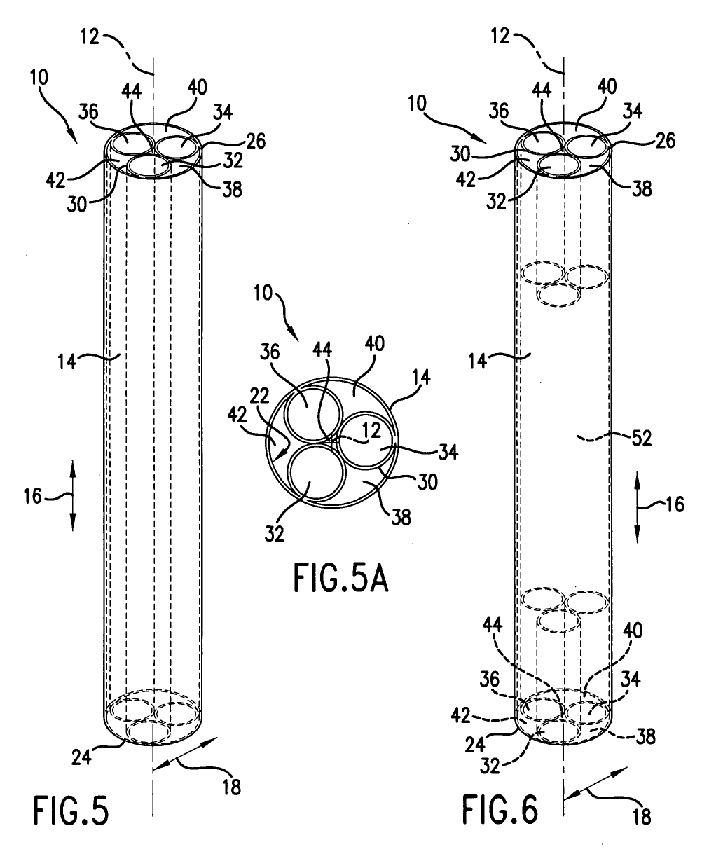

Another exemplary embodiment of the drinking straw 10 is illustrated in FIG. 6. Here, the filter member 30 has a different cross-sectional shape along its longitudinal length. The filter member 30 is located at the first end 24 and has a cross-sectional shape that is the same as the filter member 30 of FIG. 5. The filter member 30 may extend any length in from the extreme end of the outer wall 14. For example, the filter member 30 may extend from 5% to 10% of the longitudinal length of the outer wall 14. The filter member 30 is also located at the second end 26 and has a cross-sectional shape that is the same as the filter member 30 of FIG. 2. The filter member 30 may extend any distance from the extreme end of the outer wall 14. For example, the filter member 30 may extend from 1% to 20% of the longitudinal length of the outer wall 14 from the extreme second end 26. The filter member 30 is discontinuous along its longitudinal length so that an open middle portion 52 is present within the outer wall 14. The channels of the filter member 30 at the first end 24 may or may not align with the channels of the filter member 30 at the second end 26. Variation of the cross-sectional shape of the filter member 30 provides a variance in the filter member 30 that acts to block unwanted objects 60 such that a portion of the filter member 30 that cannot block a particular object 60 may be compensated for by another portion of the filter member 30 that is capable of blocking the object 60. Also, variation of the cross-sectional shape of the filter member 30 may act to increase the volumetric flow rate as a portion of the filter member 30 will have a cross-sectional shape that minimizes pressure drop.

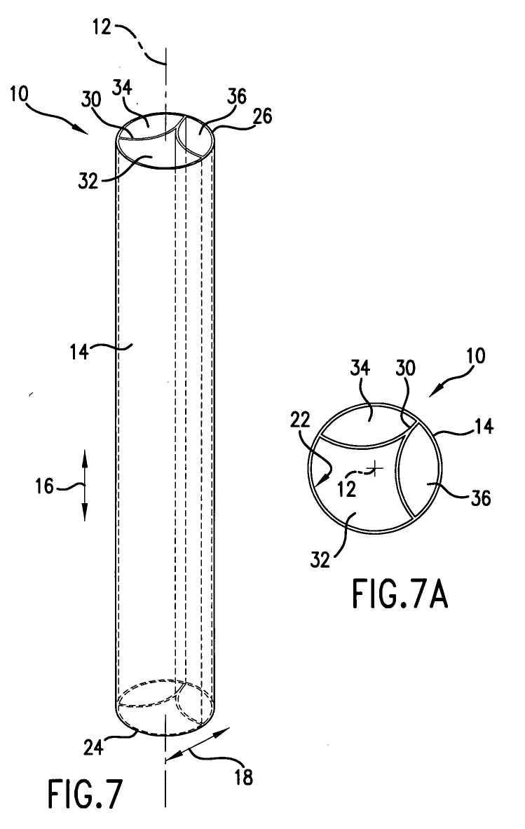

FIGS. 7 and 7A show another embodiment of the drinking straw 10 in which the filter member 30 extends along the entire longitudinal length of the outer wall 14. The filter member 30 in combination with the inner surface 22 define three channels 32, 34, and 36. The channels 32, 34, and 36 have cross sectional shapes that do not have a linear portion. Channel 32 is defined by three walls and the portion of inner surface 22 forming channel 32 has a different radius of curvature than the two portions of the filter member 30 forming the remaining part of the channel 32. Channels 34 and 36 are each formed by a pair of walls that have different radiuses of curvature. The channels are arranged so that the central axis 12 extends through the channel 32. Placement of the channel 32 through the central axis 12 may cause a lower pressure drop to be realized during use of the drinking straw 10 as a greater volume of fluid 28 may flow through the radial center portion of the outer wall 14 when suction is applied at an end of the drinking straw 12.

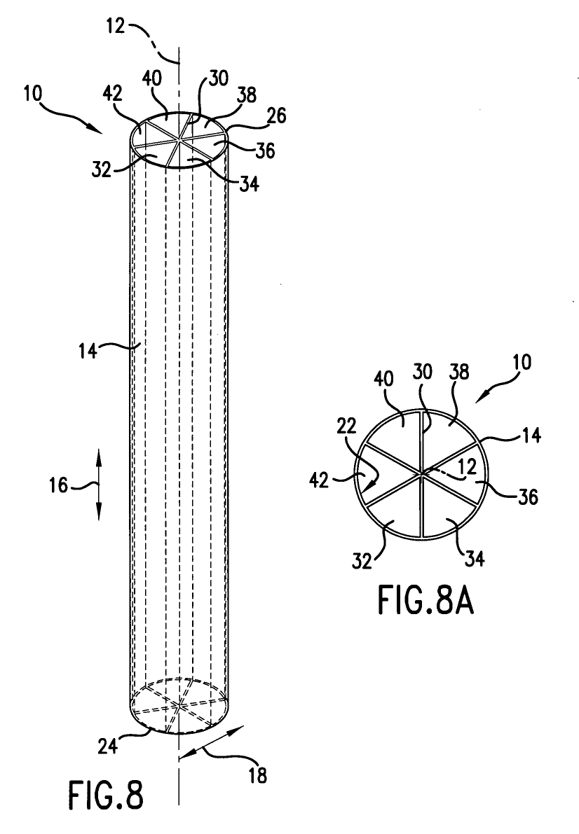

FIGS. 8 and 8A show another exemplary embodiment of the drinking straw 10 in which the filter member 30 in combination with the inner surface 22 form six equally cross-sectional shaped channels 32, 34, 36, 38, 40, and 42. The filter member 30 may extend the entire longitudinal length of the outer wall 14, and the central axis 12 does not extend through any of the channels 32, 34, 36, 38, 40, and 42. The drinking straw 10 of FIGS. 8 and 8A may be modified so that the filter member 30 is present at both ends 24 and 26 and is discontinuous along its longitudinal length so that an open middle portion 52 is defined therein. The open middle portion may extend from 2%-10%, from 10%-25%, from 25%-75%, or from 75%-98% of the longitudinal length of the outer wall 14.

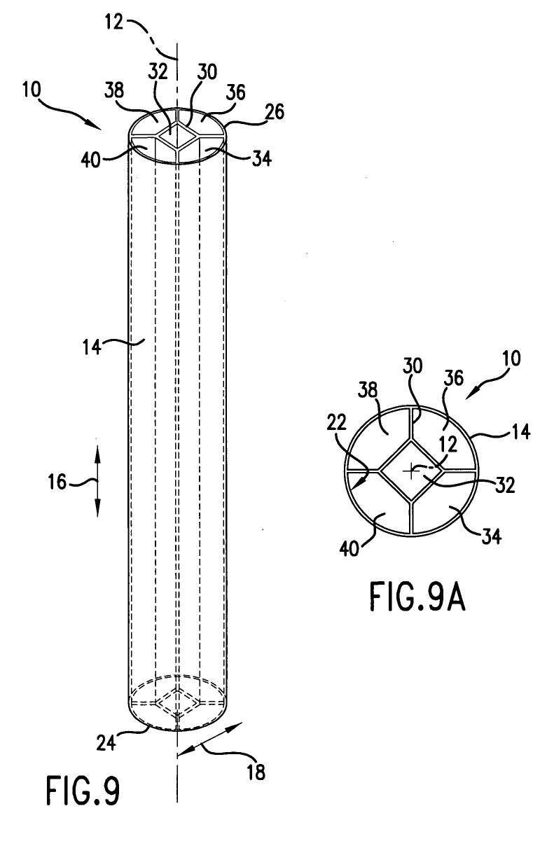

A further embodiment of the drinking straw 10 is illustrated in FIGS. 9 and 9A in which the filter member 30 completely defines a channel 32 that is square shaped and positioned such that the central axis 12 extends through the channel 32. As such, all of the cross-sectional portions of the channel 32 are linear. Placement of channel 32 at the central axis 12 may function to reduce pressure drop as a greater amount of suction force is induced at the central axis 12 than at any other portion of the drinking straw 10 in the radial direction 18. The filter member 30 in combination with the inner surface 22 define channels 34, 36, 38, and 40 that all have the same cross-sectional shape. The channels 34, 36, 38, and 40 each have a cross-sectional curved portion formed by the inner surface 22 and three cross-sectional linear portions formed by the filter member 30.

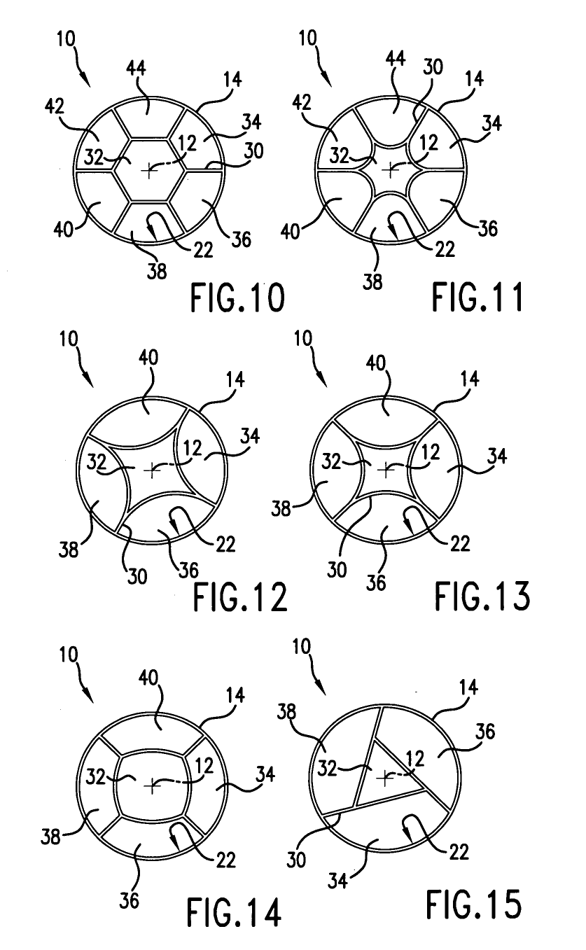

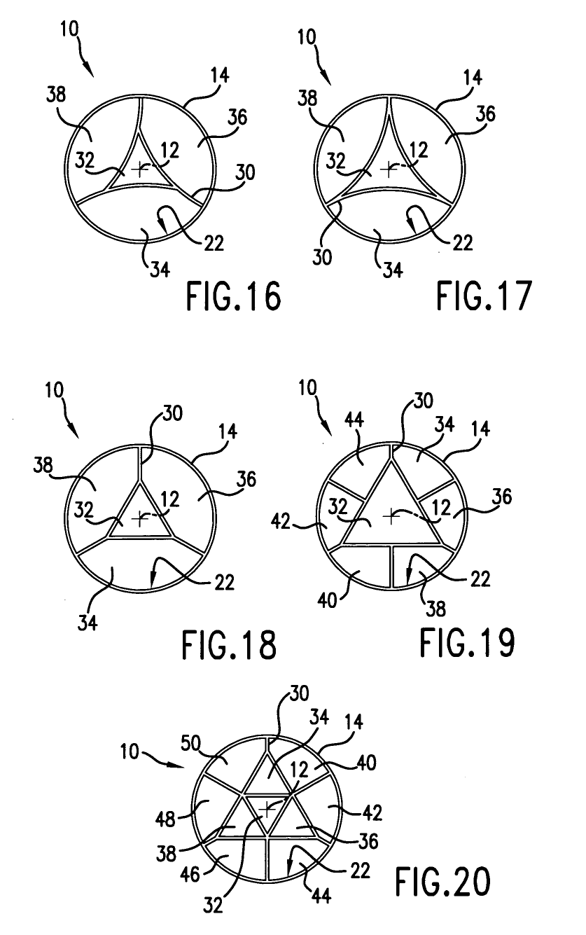

FIGS. 10-23 show other exemplary embodiments of the drinking straw 10 in which the filter member 30 is variously configured so that channels having various sizes, shapes, number and locations are realized. The filter members 30 of FIGS. 10-20 completely define a central channel 32 through which the central axis 12 extends. The channels 32 of FIGS. 10-20 are all symmetrical in that the sides forming the channels 32 all have the same shape and size. The channels 32 in FIGS. 10, 15, and 18-20 all have completely linear cross-sectional portions while the channels 32 in FIGS. 11-14, 16, and 17 feature a cross-sectional shape that does not have a linear portion. Additional channels 34, 36, 38, 40, 42, 44, 46, 48, and 50 may be present in the various embodiments of FIGS. 10-20. With respect to the embodiment in FIG. 20, the channels 34, 36, and 38 have the same cross-sectional shape as channel 32 and are completely formed by the filter member 30. Additional channels 40, 42, 44, 46, 48, and 50 are defined in part by the filter member 30 and the inner surface 22 in FIG. 20 and are shaped and sized the same as one another.

With respect to the embodiments in FIGS. 10-19, the additional channels 34, 36, 38, 40, 42, and/or 44 are all defined by both the filter member 30 and the inner surface 22 and are all sized and shaped the same as one another with respect to their particular configuration. The additional channels 34, 36, 38, 40, and/or 44 of the drinking straws 10 of FIGS. 10, 11, 13-16, and 18-20 all have at least one linear portion. The additional channels 34, 36, 38, and/or 40 of the embodiments in FIGS. 12 and 17 do not have a cross-sectional shape that has a linear portion and instead all have completely curved sides. In this regard, the additional channels 34, 36, 38, and 40 of FIG. 12 may be made so that all of the curved surfaces forming the channels 34, 36, 38, and 40 have the same radius of curvature. However, other embodiments exist in which the channels 34, 36, 38, and 40 may be formed by sides that do not have the same radius of curvature. The channels 34, 36, 38, and/or 40 of the embodiments of FIGS. 12 and 17 all have one side formed by the inner surface 22 and one side formed by the filter member 30 that is opposite from the inner surface 22.

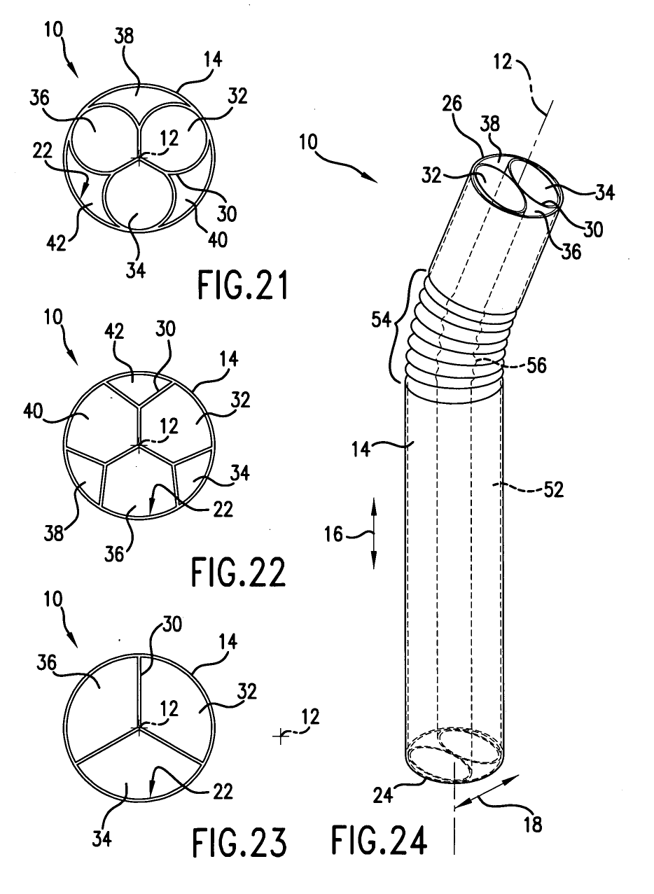

FIGS. 21-23 illustrate additional embodiments of the drinking straw 10 in which the central axis 12 does not extend through a channel. In FIGS. 21, three channels 32, 34, and 36 are formed completely by the filter member 30 and have both curved and linear portions and are all sized and shaped the same as one another. Additional channels 38, 40, and 42 formed by the filter member 30 and the inner surface 22 do not have a linear portion and are all sized and shaped the same as one another.

The exemplary embodiment in FIG. 22 includes six channels 32, 34, 36, 38, 40, and 42 that are all formed by both the filter member 30 and the inner surface 22. The channels 32, 34, 36, 38, 40 and 42 all include at least two linear portions. Channels 32, 36, and 40 are sized and shaped the same as one another, and channels 34, 38, and 42 are sized and shaped the same as one another.

The exemplary embodiment shown in FIG. 23 has three channels 32, 34, and 36 that are each sized and shaped the same as one another. The channels 32, 34, and 36 are all formed by two linear sides of the filter member 30 and by a curved side of the inner surface 22.

The drinking straw 10 may be arranged so that it is flexible to allow the ends 24 and 26 to be moved out of linear alignment with one another. Such adjustability of the drinking straw 10 may allow the end 24 to be more conveniently placed for receipt into the mouth of the user. FIG. 24 shows one embodiment in which the drinking straw 10 has a flexible feature. The outer wall 14 may have an outer wall flexible section 54 that extends some portion along the longitudinal length of the outer wall 14. A filter member flexible section 56 may also be present and may extend the same distance in the longitudinal direction 16 as that of the outer wall flexible section 54. The outer wall flexible section 54 and the filter member flexible section 56 may be rendered flexible through the use of small angled or popoid portions. The flexible sections 54 and 56 can be bent by the user to achieve a desired shape of the drinking straw 10. In other embodiments, the filter member 30 may be discontinuous such that an open middle portion 52 is present and a filter member flexible section 56 is not needed.

The variously described exemplary embodiments may be manufactured so that the filter member 30 and the outer wall 14 are made of the same material and are integrally formed with one another. Alternatively, the variously described drinking straw 10 embodiments may be made of the same material and can be formed as separate components that are subsequently attached to one another. Further, any of the previously described embodiments may be made so that the filter member 30 is present along the entire longitudinal length of the outer wall 14, or at the first and/or second ends 24, 26 of the outer wall 14. Further, although described and shown as having a completely curved outer surface 20, other embodiments are possible in which portions of or the entire outer surface 20 is not curved.

The presence of the filter member 30 may increase the structural rigidity of the drinking straw 10. In this regard, it is common for users of drinking straws 10 to chew on the drinking straws 10 during use or even at times when one is not actively drawing liquid therethrough. Forces applied by the teeth of the user may be sufficient to crush or damage the drinking straw 10 rendering it incapable of use. The filter member 30 provides lateral strength to the drinking straw 10 and prevents or minimizes damage caused by a user when applying forces from his or her teeth such as by chewing. Further, the drinking of thicker liquids, such as when consuming a milkshake, may generate forces within the drinking straw 10 that can cause it to deform or rupture. The presence of the filter member 30 may also act to prevent or minimize damage caused by these types of forces. Although any of the described variations of the filter member 30 are capable of adding increased lateral strength to the drinking straw 10, variations in which the filter member 30 extends along a greater portion of the longitudinal length may be stronger than those versions in which the filter member 30 extends a shorter distance along the longitudinal length.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

What is claimed:

1. A drinking straw, comprising:
an outer wall extending in a longitudinal direction and having a central axis located at the radial center of the outer wall that extends in the longitudinal direction, wherein the outer surface of the outer wall is curved, wherein the outer wall has a first end and a second end that is oppositely located from the first end in the longitudinal direction, wherein the first end and the second end are open to allow the flow of fluid longitudinally through the outer wall; and
a filter member that at least partially defines a channel, wherein the central axis extends through the channel.

2. The drinking straw as set forth in claim 1, wherein the filter member and the channel extend from the first end of the outer wall to the second end of the outer wall.

3. The drinking straw as set forth in claim 1, wherein the filter member and the channel are located at the first end of the outer wall and are not located at the second end of the outer wall.

4. The drinking straw as set forth in claim 1, wherein the filter member and the channel are located at the first end of the outer wall and are located at the second end of the outer wall, wherein the filter member and the channel are discontinuous in the longitudinal direction such that the filter member and the channel are not present at a location between the first end of the outer wall and the second end of the outer wall in the longitudinal direction.

5. The drinking straw as set forth in claim 1, wherein the channel is defined completely by the filter member and is not defined by the outer wall.

6. The drinking straw as set forth in claim 1, wherein the channel has a cross-sectional shape that does not have a linear portion.

7. The drinking straw as set forth in claim 1, wherein the cross-sectional shape of the filter member and the channel are constant throughout the entire longitudinal lengths of the filter member and the channel.

8. The drinking straw as set forth in claim 1, wherein the outer wall has an outer wall flexible section, and wherein the filter member has a filter member flexible section, wherein the outer wall flexible section and the filter member flexible section are capable of being bent such that the opened first end and the opened second end of the outer wall are moved out of alignment with one another in the longitudinal direction.

9. The drinking straw as set forth in claim 1, wherein the filter member and the inner surface of the outer wall define a second channel, wherein the filter member and the inner surface of the outer wall define a third channel, wherein the central axis does not extend through the second channel, and wherein the central axis does not extend through the third channel.

10. A drinking straw, comprising:
an outer wall extending in a longitudinal direction and having an inner surface and an outer surface, wherein the outer wall has a first end and a second end that is oppositely located from the first end in the longitudinal direction, wherein the first end and the second end are open to allow the flow of fluid longitudinally through the outer wall; and
a filter member contiguous with the outer wall, wherein a channel is at least partially defined by the filter member and wherein the channel has a cross-sectional shape that does not have a linear portion.

11. The drinking straw as set forth in claim 10, wherein the outer wall has a central axis located at a radial center of the outer wall that extends in the longitudinal direction, wherein the outer surface of the wall is curved, and wherein the central axis extends through the channel.

12. The drinking straw as set forth in claim 10, wherein the filter member and the channel extend from the first end of the outer wall to the second end of the outer wall.

13. The drinking straw as set forth in claim 10, wherein the filter member and the channel are located at the first end of the outer wall and are not located at the second end of the outer wall.

14. The drinking straw as set forth in claim 10, wherein the filter member and the channel are located at the first end of the outer wall and are located at the second end of the outer wall, wherein the filter member and the channel are discontinuous in the longitudinal direction such that the filter member and the channel are not present at a location between the first end of the outer wall and the second end of the outer wall in the longitudinal direction.

15. The drinking straw as set forth in claim 10, wherein the channel has a circular cross-sectional shape, and wherein the channel is defined completely by the filter member and is not defined by the outer wall.

16. The drinking straw as set forth in claim 10, wherein the cross-sectional shape of the filter member and the channel are constant throughout the entire longitudinal lengths of the filter member and the channel.

17. The drinking straw as set forth in claim 10, wherein the outer wall has an outer wall flexible section, and wherein the filter member has a filter member flexible section, wherein the outer wall flexible section and the filter member flexible section are capable of being bent such that the opened first end and the opened second end of the outer wall are moved out of alignment with one another in the longitudinal direction.

18. The drinking straw as set forth in claim 10, wherein the filter member and the inner surface of the outer wall define a second channel, wherein the filter member and the inner surface of the outer wall define a third channel.

19. A drinking straw, comprising:
an outer wall extending in a longitudinal direction, wherein the outer wall has a first end and a second end that is oppositely located from the first end in the longitudinal direction, wherein the first end and the second end are open to allow the flow of fluid longitudinally through the outer wall; and
a filter member contiguous with the outer wall, wherein at least three channels are at least partially defined by the filter member, wherein the filter member and the three channels are located at the first end of the outer wall and are located at the second end of the outer wall, wherein the filter member and the three channels are discontinuous in the longitudinal direction such that the filter member and the three channels are not present at a location between the first end of the outer wall and the second end of the outer wall in the longitudinal direction.

20. The drinking straw as set forth in claim 19, wherein the three channels each have a cross-sectional shape that has a linear portion.
